(19) United States
(12) Patent Application Publication
(10) Pub. No.: US 2007/0256237 A1
(43) Pub. Date: Nov. 8, 2007

(54) SYSTEM AND METHOD FOR ATTACHING A DRAIN ASSEMBLY TO A PLUMBING FIXTURE

(76) Inventor: Robert H. Mayer, Deerfield, FL (US)

Correspondence Address: PAUL D. BIANCO: FLEIT, KAIN, GIBBONS,;GUTMAN, BONGINI, & BIANCO P.L., 21355 EAST DIXIE HIGHWAY, SUITE 115, MIAMI, FL, 33180, US

(21) Appl. No.: 11/744,414

(22) Filed: May 4, 2007

Related U.S. Application Data
(63) Continuation-in-part of application No. PCT/US06/17251, filed on May 5, 2006.
(63) Continuation-in-part of application No. 11/123,493, filed on May 5, 2005.
Application No. 11/123,493 is a continuation-in-part of application No. 11/009,565, filed on Dec. 10, 2004.

(51) Int. Cl. B25B 13/08

(52) U.S. Cl. 4/650; 81/73

(57) ABSTRACT

The present invention provides a kit for affixing a drain assembly in a drain port in plumbing fixture. The drain assembly includes a drain ring affixed to a drain pipe. The drain pipe is positionable through the drain port in a bottom surface of the plumbing fixture, such that the drain sink abuts the upper surface of the plumbing fixture. The drain pipe extends through the drain port, past an underside surface of the plumbing fixture surrounding the drain port. A drain nut is rotatably fastened onto the drain pipe. The drain nut includes a first and second of bore therein. A drain nut driver tool is provided, which includes first and second angular extensions for engaging the drain nut. The drain nut driver tool engages the drain nut by removably positioning the first and second angular extensions about the drain pipe into the first and second of bores of the drain nut. The drain nut driver tool is rotated about the drain pipe to secure the drain nut onto the drain pipe.

### CROSS-REFERENCE TO RELATED APPLICATIONS

This application is a continuation-in-part of PCT International Application No. PCT/US2006/017251, entitled System and Method for Attaching a Drain Assembly to a Plumbing Fixture filed May 5, 2006. This application is also a continuation-in-part of U.S. patent application Ser. No. 11/123,493 entitled System and Method for Attaching a Drain Assembly to a Plumbing Fixture filed May 5, 2006, which is a continuation-in-part of U.S. patent application Ser. No. 11/009,565 entitled System and Method for Attaching a Drain Assembly to a Plumbing Fixture filed Dec. 10, 2004. The entirety of each of the above-identified patent applications is incorporated herein by reference.

### FIELD OF THE INVENTION

The present invention relates generally to plumbing fixture drainage systems, and more particularly to a drain nut, tool, and method for installing the drain nut onto a drain pipe, thereby securing the drain pipe to the plumbing fixture.

### BACKGROUND OF THE INVENTION

Conventionally, drain assemblies are secured to plumbing fixtures such as kitchen, bathroom and utility room lavatories or sinks, by means of a nut disposed on the underside of a sink. The drain nut is threadably engaged on a relatively large diameter, hollow tubular, externally threaded pipe that extends from the drain downwardly through an opening in the bottom of the sink.

The drain assembly typically includes an annular collar which surrounds the drain, resting atop and about the periphery of an opening through the bottom portion of the sink. The drain pipe extends downwardly through the opening past the underside surface of the sink. The drain assembly is secured by engaging the drain nut with the drain pipe and manually advancing the drain nut the full length of the drain pipe, until the drain nut resides in abutment against the undersurface of the sink

The drain nut is initially tightened by hand. However, in order to adequately secure the drain assembly to the sink a tool, such as a basin wrench or a channel lock wrench, is utilized to advance the drain nut to firmly secure the drain nut against the underside of the sink. However, due to the space limitations engaging the drain nut with the tool can be a difficult and time consuming process.

Thus, there exists a need for a system and method for attaching a drain assembly to a plumbing fixture.

### SUMMARY OF THE INVENTION

The present invention provides a drain connection kit for connecting a drain pipe to a plumbing fixture. A drain nut is provided which includes first and second bores and an annular wall with a threading. The annular wall threading is configured and dimensioned to threadably engage the drain pipe exterior threading. A driver tool is provided for engaging the drain nut to rotate the drain nut onto the drain pipe. The driver tool has a first angular extension configured and dimensioned to removably engage the first bore and a second angular extension configured and dimensioned to removably engage the second bore, such that rotation of the driver tool about the drain pipe rotates the drain nut.

The present invention also provides a plumbing fixture, wherein the plumbing fixture can be a sink, lavatory, tub, shower, or any other receptacle or vessel having a drain. The plumbing fixture includes a drain port defining a passage extending through an upper surface to an underside surface of the plumbing fixture. A drain pipe having first and second ends and an exterior threading is included. The drain pipe is positionable through the passage, with the second end of the drain pipe extending past the underside surface of the plumbing fixture. A drain ring is affixed to the first end of the drain pipe, which is positionable about the upper surface of the plumbing fixture, surrounding the drain port. A drain nut is provided which includes first and second bores and an annular wall with a threading. The annular wall threading is configured and dimensioned to threadably engage the drain pipe exterior threading. A driver tool is provided for engaging the drain nut to rotate the drain nut onto the drain pipe. The driver tool has a first angular extension configured and dimensioned to removably engage the first bore and a second angular extension configured and dimensioned to removably engage the second bore such that rotation of the driver tool about the drain pipe rotates the drain nut.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 depicts an exploded view of an embodiment of the drain connector kit of the present invention;

FIG. 2 depicts the drain connector kit of FIG. 1;

FIG. 3 is a perspective view of the drain nut shown in FIG. 1;

FIG. 4 is a top view of a drain nut with several pairs of bores;

FIG. 5 depicts the drain nut driver shown in FIG. 1;

FIG. 6 is a sectional view of the drain connector kit of FIG. 1 installing a drain assembly into a drain port in a bottom portion of a sink;

FIG. 7 depicts another embodiment of a drain nut driver of the present invention;

FIG. 8 is an isometric view of the drain nut driver of FIG. 7 installing a drain nut onto a threaded drain pipe;

FIG. 9 is a top perspective view of another embodiment of a drain nut driver of the present invention;

FIG. 10 is a top view of the drain nut driver of FIG. 9;

FIG. 11 is an exploded view of the drain nut driver of FIG. 9;

FIG. 12 is a bottom perspective view of the drain nut driver of FIG. 9;

FIG. 13 is a top view of the drain nut engaging structure of the drain nut driver of FIG. 9;

FIG. 14 is a bottom view of the drain nut engaging structure of the drain nut driver of FIG. 9;

FIG. 15 is a top perspective view of another embodiment of a drain nut driver of the present invention;

FIG. 16 is a top view of the drain nut driver of FIG. 15;

FIG. 17 is side view of the drain nut driver of FIG. 15;

FIG. 18 depicts the drain nut driver of FIG. 15 including a drain nut therein;

FIG. 19 is a top perspective view of a drain nut driver of the present invention including an insertion piece;

FIG. 20 is an exploded view of the drain nut driver and insertion piece of FIG. 19;

FIG. 21 is a top perspective view of the insertion piece of FIG. 19;

FIG. 22 is a top view of an alternative insertion piece of the present invention; and

FIG. 23 is an exploded view of a drain nut driver of the present invention and the alternative insertion piece.

### DETAILED DESCRIPTION OF THE INVENTION

The present invention provides a drain connector kit including a drain nut and drain nut driver. The drain nut and drain nut driver are pairingly configured to allow installation of a drain assembly with a driver unit, such as a mechanical or electric driver.

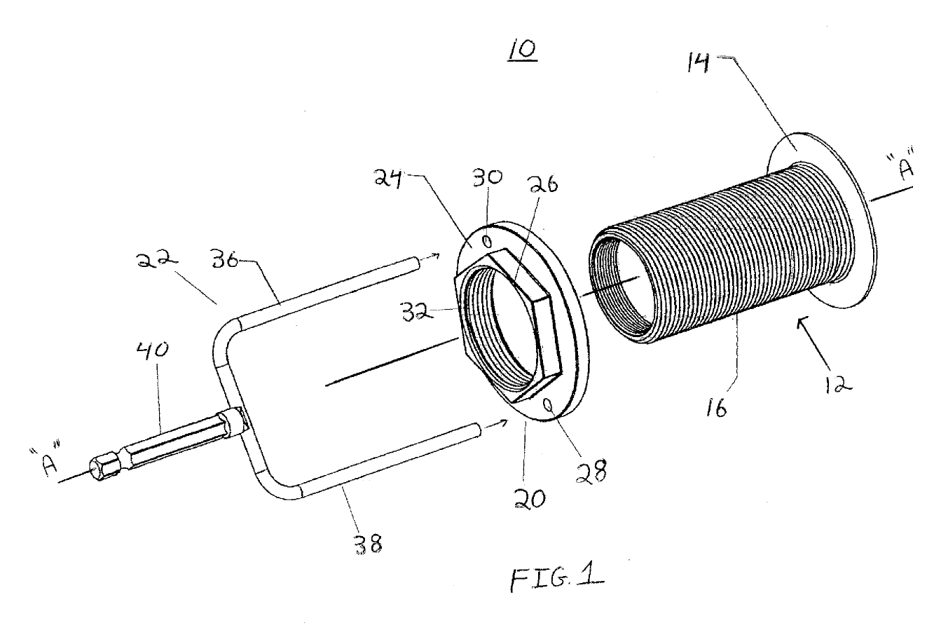

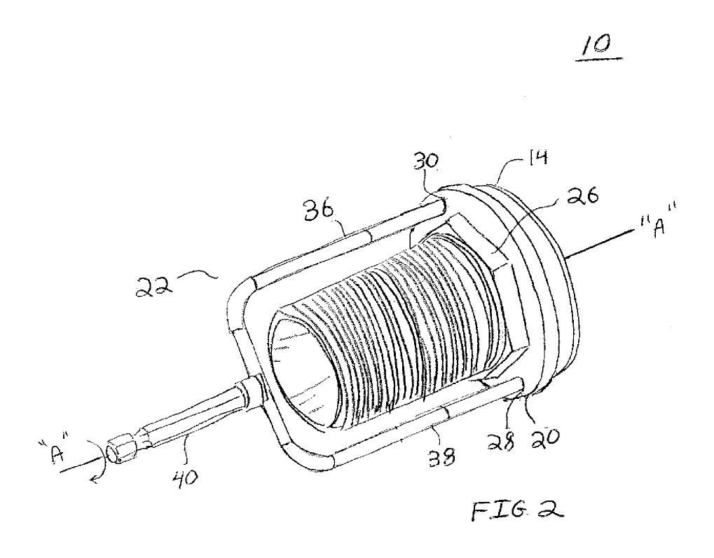

Referring now to the drawings in which like reference designators refer to like elements, there is shown in FIGS. 1 and 2 a drain connector kit 10 of the present invention, including a drain assembly 12. The drain assembly 12 includes a drain ring 14 connected to an externally threaded drain pipe 16. The drain connector kit 10 includes a drain nut 20 to threadably engage the drain pipe 16. A drain nut driver 22 is utilized to drive and thread the drain nut 20 onto the threaded drain pipe 16.

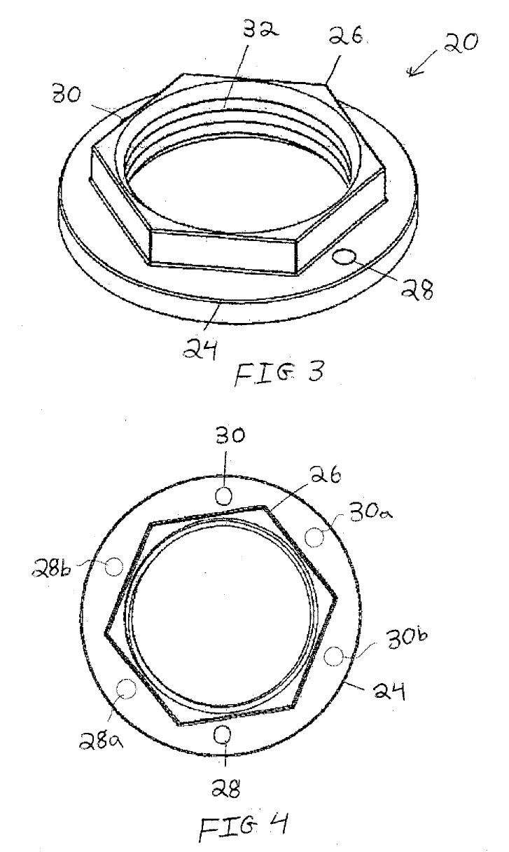

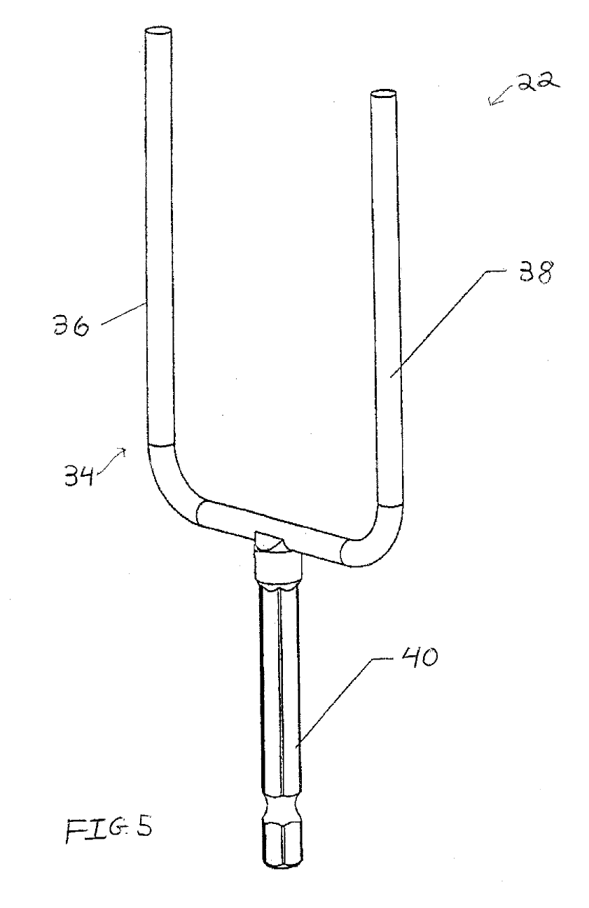

Referring to FIG. 3, the drain nut 20 includes a flange portion 24 and a nut portion 26. The flange portion 24 includes a pair of bores 28 and 30 configured and dimensioned to be engaged by the drain nut driver 22. The drain nut 20 is internally threaded 32 for engagement to the drain pipe 16. As shown in FIG. 4, while the drain nut 20 is shown having a pair of bores 28 and 30, it is contemplated that the drain nut 20 can include any number of bores 28, 30, 28a-b and 30 a-b. These bores 28, 30, 28a-b and 30 a-b can be opposingly, uniformly, symmetrically, or asymmetrically positioned about the flange portion 24 of the drain nut 20.

Additionally, the bores 28 and 30 are depicted having a circular cross sectional area. However, it is contemplated that the cross sectional area of bores 28 and 30 can have other shapes, including, but not limited to, rectangular, triangular, elliptical, octagonal, hexagonal, diamond, star, etc, and combinations thereof.

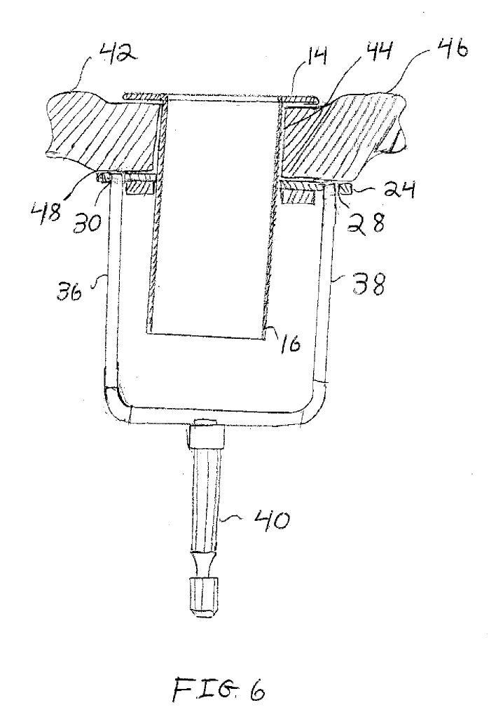

Referring to FIG. 5, the drain nut driver 22 includes a drain nut engaging structure 34. The drain nut engaging structure 34 is substantially U-shaped, having a pair of extensions 36 and 38. The extensions 36 and 38 are provided in a spaced apart relationship for alignment with the pair of bores 28 and 30 in the drain nut 20. The extensions 36 and 38 are shaped, sized, and dimensioned to one each slidingly engage the bores 28 and 30.

The extensions 36 and 38 are depicted having a circular cross sectional area. However, it is contemplated that the cross sectional area of a extensions 36 and 38 can have other shapes, including but not limited to, rectangular, triangular, elliptical, octagonal, hexagonal, diamond, star, etc., matching the cross sectional area of the bores 28 and 30. The present invention contemplates that extensions 36 and 38 can have a shape that is different than the shape of bores 28 and 30. In the instance where the drain put 20 includes multiple pairs of bores, the extensions 36 and 38 nay be selectively positioned in any one of the pairs of bores.

The drain nut engaging structure 34 is affixed to a drive shaft 40. The drive shaft 40 is configured for engagement by a driver unit (not shown), such as a mechanical or electric driver. For example, the drive shaft 40 may have substantially hexagonal cross section area for insertion into and engagement by a chuck of the electric drill. Upon securement of drive shaft 40 in the drill chuck, activation of the electric drill rotates the drain nut engaging structure 34. The electric driver can be used to rotate the drain nut engaging structure 34 in either a clockwise or counter-clockwise direction. While the drain nut engaging structure 34 is shown having an opposing pair of extensions 36 and 38, it is contemplated that the drain nut engaging structure 34 can include any number of extensions, uniformly, symmetrically, or asymmetrically positioned about the drive shaft 40 for engagement with the bores of the drain nut 20.

Referring to FIG. 6, the drain assembly 12 is installed into a plumbing fixture 42. The plumbing fixture 42 can be a sink, lavatory, tub, shower, or any other receptacle or vessel having a drain. The drain pipe 16 is positioned through a drain port 44 in an upper surface 46 of the plumbing fixture 42, such that the drain ring 14 is positioned on the upper surface 46 of the plumbing fixture 42. The drain pipe 16 is of sufficient length such that the drain pipe 16 extends through the drain port 44, beyond an underside surface 48 of the plumbing fixture 42. The drain nut 20 is threaded onto the drain pipe 16, wherein the internal threads 32 of the drain nut 20 engage the threaded drain pipe 16. The drain nut 20 is positioned on the drain pipe 16, such that the flange portion 24 of the drain nut 20 is proximal to the underside surface 48 of the plumbing fixture 42.

The drain nut driver 22 is attached to a driver unit, such as an electric drill, wherein the drive shaft 40 is inserted into and engaged by a drill chuck of the electric drill. Upon securement of drive shaft 40 in the chuck, activation of the electric drill rotates the drain nut driver 22. The electric drill can be used to rotate the drain nut engaging structure 34 in either a clockwise or counter-clockwise direction.

The drain nut driver 22 engages the drain nut 20 by slideably inserting the opposing pair of extensions 36 and 38 of the drain nut engaging structure 34 into the drain nut bores 28 and 30, wherein the drive shaft 40 is substantially aligned along a central longitudinal axis “A” of the drain pipe 16. The electric drill is activated to rotate, thread, the drain nut 20 onto the drain pipe 16. To secure the drain assembly 12 in position, the drain nut 20 is threaded onto the drain pipe 16, wherein the flange portion 24 of the drain nut 20 abuts the underside surface 48 of the plumbing fixture 42. Sufficient torque is applied to the drain nut 20, securing the drain assembly 12 into position.

Similarly, to remove the drain assembly t2, the drain nut driver 22 engages the drain nut 20 by slideably inserting the opposing pair of extensions 36 and 38 of the drain nut engaging structure 34 into the drain nut bores 28 and 30, The electric drill is activated to rotate the drain nut 20 off the drain pipe 16. The drain nut 20 is removed from the drain pipe 16. The drain pipe 16 is then removed from the drain port 44.

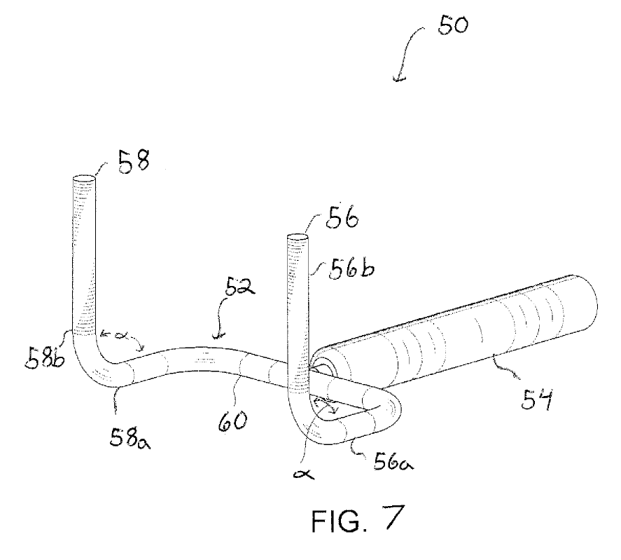

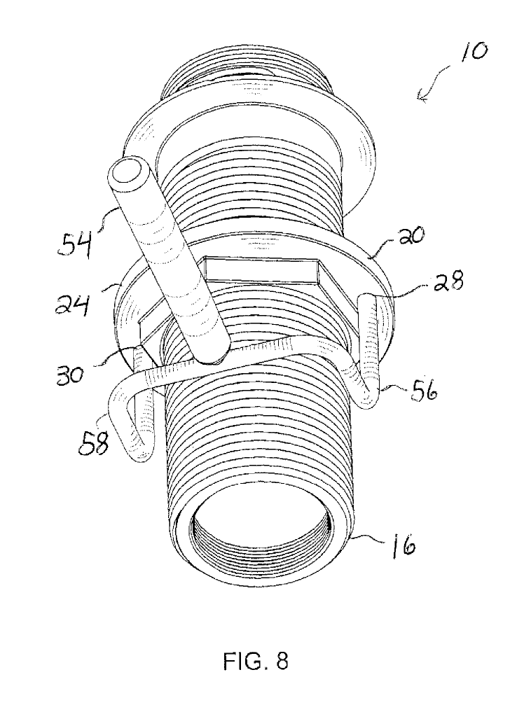

Referring to FIGS. 7 and 8, another embodiment of a drain nut driver 50 includes a drain nut engaging structure 52 affixed to a handle portion 54. The drain nut engaging structure 52 includes a pair of angular extensions 56 and 58. The extensions 56 and 58 each include extending sections 56a and 58a and engaging sections 56b and 58b. The engaging sections 56b and 58b are positioned at an angle “α” with respect to the extending section 56a and 58a. For example, the angular extension 56 and 58 can be substantially L-shaped, having an angle “α” of about 90°. The extensions 56 and 58 are provided in a spaced apart relationship for positioning about the drain pipe 16 and alignment with the pair of bores 28 and 30 in the drain nut 20. The extensions 56 and 58 are shaped, sized, and dimensioned to one each slidingly engage the bores 28 and 30.

The angular extensions 56 and 58 are depicted having a circular cross sectional area. However, it is contemplated that the cross sectional area of extensions 56 and 58 can halve other shapes, including but not limited to, rectangular, triangular, elliptical, octagonal, hexagonal, diamond, star, etc., matching the cross sectional area of the bores 28 and 30. The present invention contemplates that extensions 56 and 58 can have a shape that is different than the shape of bores 28 and 30. In the instance where the drain nut 20 includes multiple pairs of bores, the extensions 56 and 58 may be selectively positioned in any one of the pairs of bores.

A crossbar 60 extends a length sufficient to accommodate the diameter of the drain pipe 16. The extending sections 56a and 58a each have a length such that when each of the engaging sections 56b and 58b are coupled to one of the drain nut bores 28 and 30, the drain nut driver 50 can rotate freely about the drain pipe 16 to selectively tighten or loosen the drain nut 20 regardless of the length of the drain pipe 16. Although the engaging sections 56b and 58b are shown being substantially perpendicular to the extending sections 56a and 58b, (i.e., substantially L-shaped as previous described) any suitable angular relationship could be used.

In use, the drain nut 20 is threaded onto the drain pipe 16 with the drain nut driver 50. The drain nut 20 is threaded onto the drain pipe 16, wherein the internal threads 32 of the drain nut 20 engage the threaded drain pipe 16. The drain nut 20 is positioned on the drain pipe 16, such that the flange portion 24 of the drain nut 20 would be proximal to the underside surface of the plumbing fixture.

The drain nut driver 50 engages the drain nut 20 by positioning the angular extensions 56 and 58 about the drain pipe. The engaging sections 56b and 58b of each of the angular extensions 56 and 58 are slidably inserted into the drain nut bores 28 and 30. The handle portion 54 is rotated around the drain pipe 16, threading the drain nut 20 onto the drain pipe 16. In comparison, the shaft 40 of drain nut driver 22 is rotated along a central longitudinal axis “A” of the drain pipe 16. To secure the drain assembly 10 in position, the drain nut 20 is threaded onto the drain pipe 16, wherein the flange portion 24 of the drain nut 20 abuts an underside surface of the plumbing, fixture. Sufficient torque is applied to the drain nut 20, securing the drain assembly 10 into position.

Similarly, to remove the drain assembly 10, the drain nut driver 50 engages the drain nut 20 by positioning the angular extensions 56 and 58 about the drain pipe 16. The engaging sections 56b and 58b of each of the angular extensions 56 and 58 are slidably inserted into the drain nut bores 28 and 30. The handle portion 54 is rotated around the drain pipe 16, rotating the drain nut 20 off the drain pipe 16. The drain nut 20 is removed from the drain pipe 16.

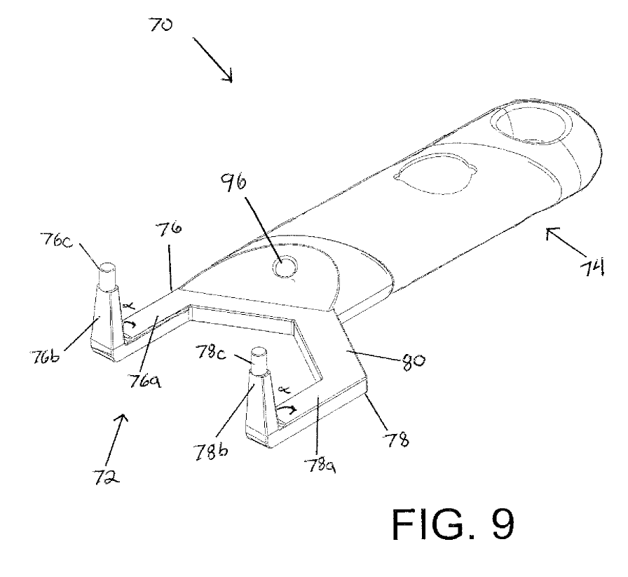

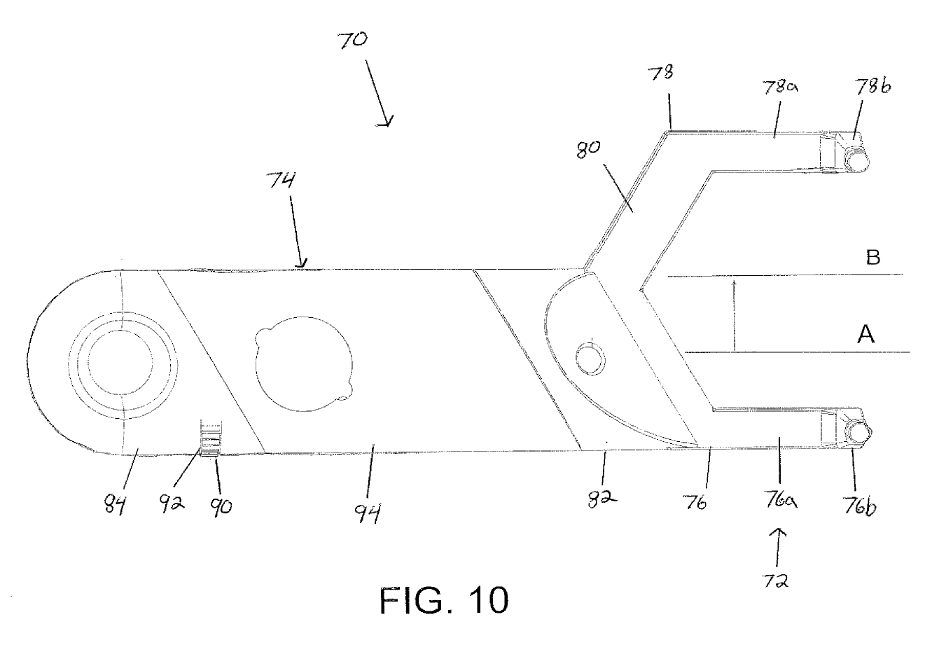

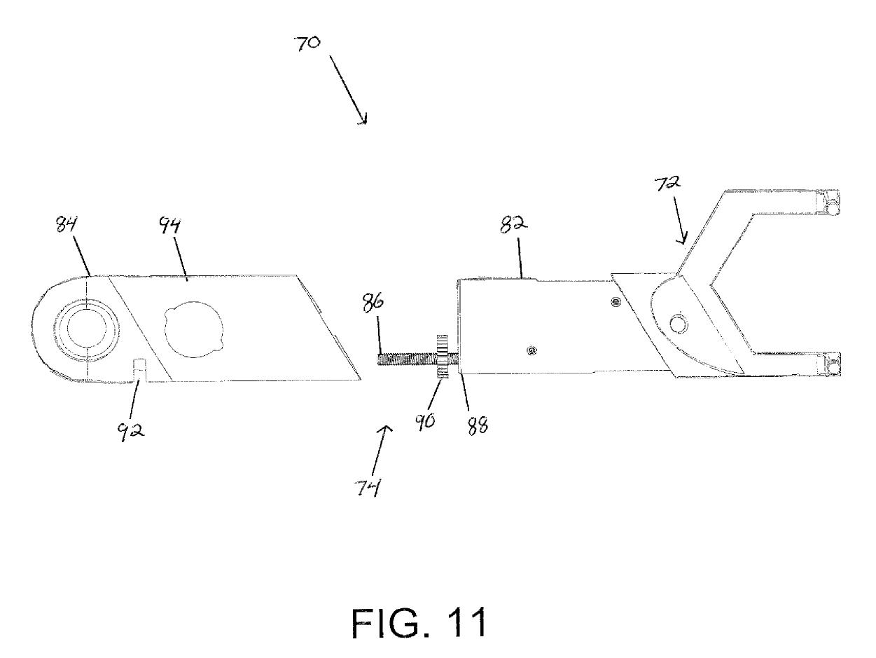

Referring to FIGS. 9 and 10, another embodiment of a drain not driver 70 includes a drain nut engaging structure 72 affixed to a handle portion 74. The drain nut engaging structure 72 includes a pair of angular extensions 76 and 78. The extensions 76 and 78 each include extending sections 76a and 78a and engaging sections 76b and 78b. The engaging sections 76b and 78b are positioned at an angle “α” with respect to the extending section 76a and 78a. For example, the angular extension 76 and 78 can be substantially L-shaped, having an angle “α” of about 90°.

The extensions 76 and 78 are provided in a spaced apart relationship for positioning about the drain pipe 16 and alignment with the pair of bores 28 and 30 in the drain nut 20. The extensions 76 and 78 are provided in an offset relation to a central longitudinal axis “A” of the handle portion 74, such that a central axis “B” of the extensions 76 and 78 is offset from the central axis longitudinal axis “A” of the handle portion 74. To provide the extension offset a lever arm 80 is provided in extension 78. The extension offset provides leverage to a user of the drain nut driver 70 to aid in the tightening or removal of the drain nut 20. The tips 76c and 78c of the extensions 76 and 78 are shaped, sized, and dimensioned to one each slidingly engage the bores 28 and 30.

The tips 76c and 78c of the extensions 76 and 78 arc depicted having a circular cross sectional area. However, it is contemplated that the cross sectional area of tips 76c and 78c of the extensions 76 and 78 can have other shapes, including but not limited to, rectangular, triangular, elliptical, octagonal, hexagonal, diamond, star, etc., matching the cross sectional area of the bores 28 and 30. The present invention contemplates that extensions 76 and 78 can have a shape that is different than the shape of bores 28 and 30. In the instance where the drain nut 20 includes multiple pairs of bores, the extensions 76 and 78 may be selectively positioned in any one of the pairs of bores.

As best seen in FIG. 10, the lever arm 80 extends a length sufficient to accommodate the diameter of the drain pipe 16. The extending sections 76a and 78a each has a length such that when each of the engaging sections 76b and 78b is coupled to one of the drain nut bores 28 and 30, the drain nut driver 70 can rotate freely about the drain pipe 16 to selectively tighten or loosen the drain nut 20 regardless of the length of the drain pipe 16. Although the engaging sections 76b and 78b are shown being substantially perpendicular to the extending sections 76a and 78a, (i.e., substantially L-shaped as previous described) any suitable angular relationship could be used.

Referring to FIGS. 10 and 11, the length of the handle portion 74 is adjustable. The handle portion 74 includes all inner handle portion 82, affixed to the drain nut engaging structure 72, and a hollow outer handle portion 84 slidingly positioned onto the inner handle portion 84. A threaded member 86 is affixed to an end 88 of the inner handle portion 82, where an adjustment control member 90 can be threadably positioned on the threaded member 86. When assembled, the outer handle portion 84 is slidingly positioned on the inner handle portion 82, where the adjustment control member 90 is rotatably positioned in a slotted section 92 of the outer handle portion 84 and threaded onto the threaded member 86. A rotation of the adjustment control member 90 on the threaded member 86, moves the adjustment control member 90 along the threaded member 86 such that the outer handle portion 84 is moved along the inner handle portion 82. In this manner, the length of the handle portion 74 can be adjusted.

The outer handle portion 84 can further include a gripping element 94 positioned about the outer handle portion 84. The gripping element 94 can include a textured surface or coating about the outer handle portion 84, such that a user can more securely grip the drain nut driver 70, decreasing the likelihood of slipping.

Alternatively, the gripping element 94 can include an outer sleeve positioned about the outer handle portion 84. The outer sleeve can be made of a flexible material, which can be securely positioned about the outer handle portion 84, such that a user can more securely grip the drain nut driver 70, decreasing the likelihood of slipping. The outer sleeve can further include a textured surface, which can further decrease the likelihood of slipping.

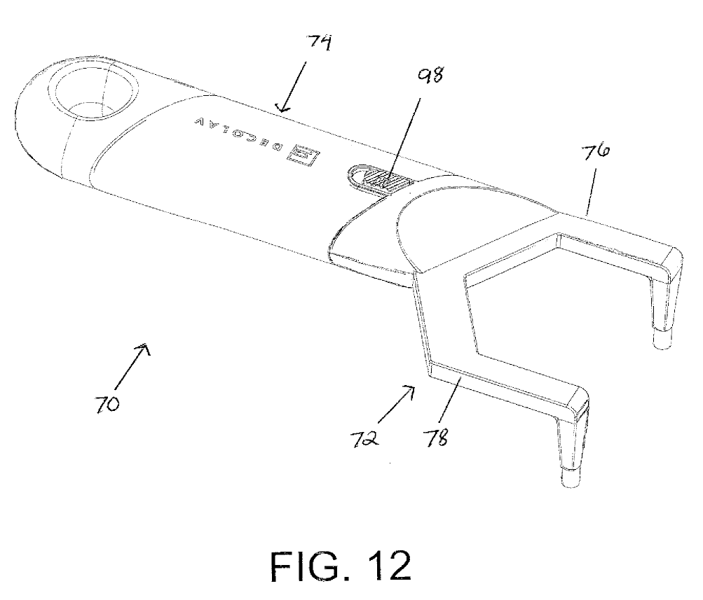

Referring to FIGS. 9 and 12, the drain nut driver 70 can include a light element 96 positioned adjacent to the extensions 76 and 78. The light element can be turn on and off by a switch 98 positioned in the handle portion 74. The light element 98 can be used to illuminate the drain nut 20, thereby facilitating the drain nut driver 70 engagement of the drain nut 20.

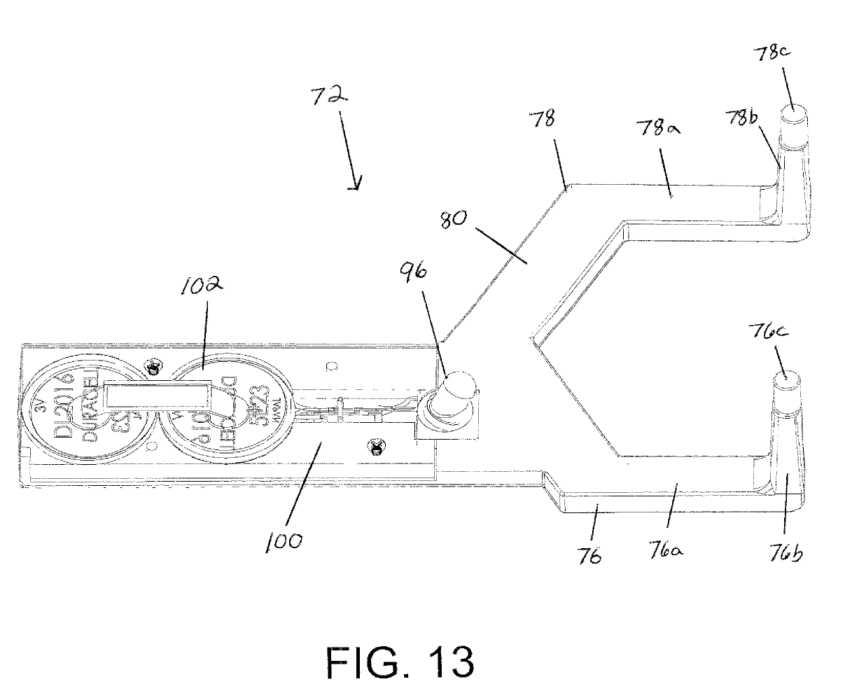

Referring to FIG. 13, the drain nut engaging structure 72 is formed of a unitary construction having an elongated portion 100 extending into the extensions 76 and 78. As previously discussed, the extensions 76 and 78 each include extending sections 76a and 78a and engaging sections 76b and 78b. The engaging sections 76b and 78b are positioned at an angle “α” with respect to the extending section 76a and 78a. For example, the angular extension 76 and 78 can be substantially L-shaped, having an angle “α” of about 90°.

The extensions 76 and 78 are provided in a spaced apart relationship for positioning about the drain pipe 16 and alignment with the pair of bores 28 and 30 in the drain nut 20. The extensions 76 and 78 are provided in an offset relation to a central longitudinal axis “A” of the elongated portion 100, where the central longitudinal axis “A” of the elongated portion 100 is the same as that for the handle portion 74, such that a central axis “B” of the extensions 76 and 78 is offset from the central axis longitudinal axis “A” of the handle portion 74.

The nut engaging structure 72 is made of a material of sufficient strength to allow for the installation and removal of the drain nut. For example, the nut engaging structure 72 can be made of a metal, hard plastic, composite material, and the like.

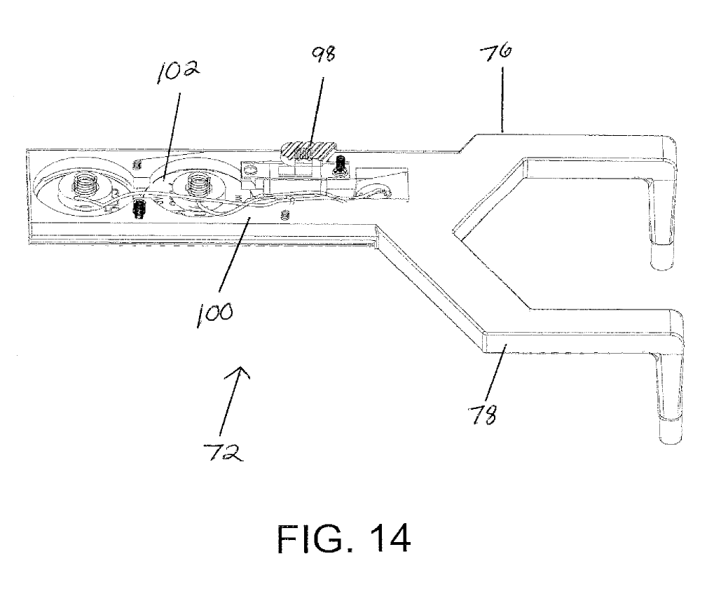

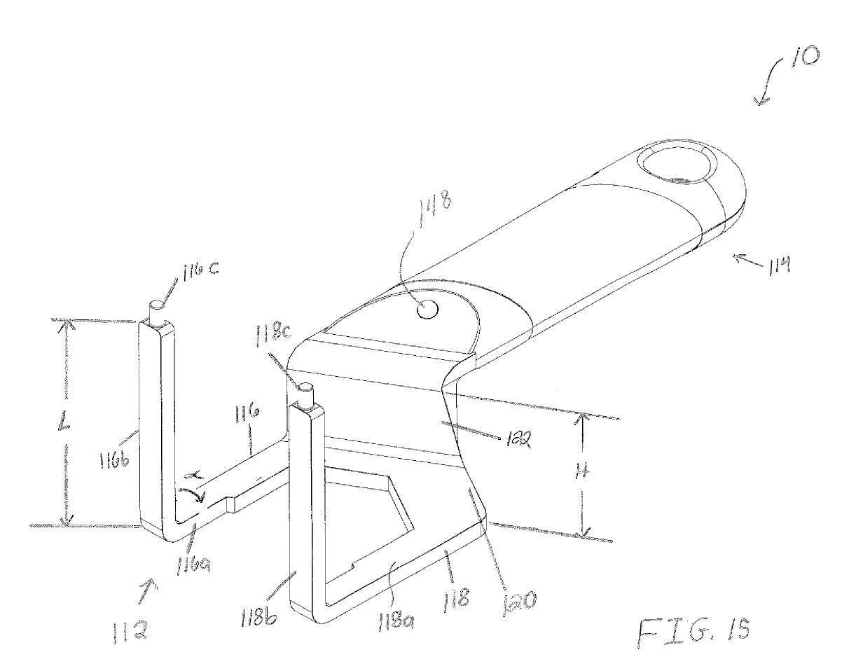

Referring to FIGS. 13 and 14, the light element is positioned on the elongated portion 100 of the drain nut engaging structure 72, proximal to the extensions 76 and 78, where at least a portion of the light element extends thought the handle portion 74. Similarly, the switch 98 is positioned on the elongated portion 100 of the drain nut engaging structure 72, where the switch 98 can be positioned on the opposite side or the same side on the elongated portion 100 of the drain nut engaging stricture 72. A power supply 102, is positioned on/in the elongated portion 100 of the drain nut engaging structure 72 and operably connected to the switch 98 aid the light element, such that an actuation of the switch 98 can optionally turn the light element on and off. The power supply 102 can take the form of at least one battery, where the battery is of sufficient size to fit within the handle portion 74.

In use, the drain nut 20 is threaded onto the drain pipe 16 with the drain nut driver 70. The drain nut 20 is threaded onto the drain pipe 16, wherein the internal threads 32 of the drain nut 20 engage the threaded drain pipe 16. The drain nut 20 is positioned on the drain pipe 16, such that the flange portion 24 of the drain nut 20 would be proximal to the underside surface of the plumbing fixture.

The drain nut driver 70 engages the drain nut 20 by positioning the angular extensions 76 and 78 about the drain pipe. The engaging sections 76b and 78b of each of the angular extensions 76 and 78 are slidably inserted into the drain nut bores 28 and 30. The light element 98 can be turned on to aid in the placement of the engaging sections 76b and 78b into the drain nut bores 28 and 30.

The handle portion 74 is rotated around the drain pipe 16, threading die drain nut 20 onto the drain pipe 16. To secure the drain assembly in position, the drain nut 20 is threaded onto the drain pipe 16, wherein the flange portion 24 of the drain nut 20 abuts an underside surface of the plumbing fixture. Sufficient torque is applied to the drain nut 20, securing the drain assembly 10 into position.

Similarly, to remove the drain assembly 10, the drain nut driver 70 engages the drain nut 20 by positioning the angular extensions 76 and 78 about the drain pipe 16. The engaging sections 76b and 78b of each of the angular extensions 76 and 78 are slidably inserted into the drain nut bores 28 and 30. The handle portion 74 is rotated around the drain pipe 16, rotating the drain nut 20 off the drain pipe 16. The drain nut 20 is removed from the drain pipe 16.

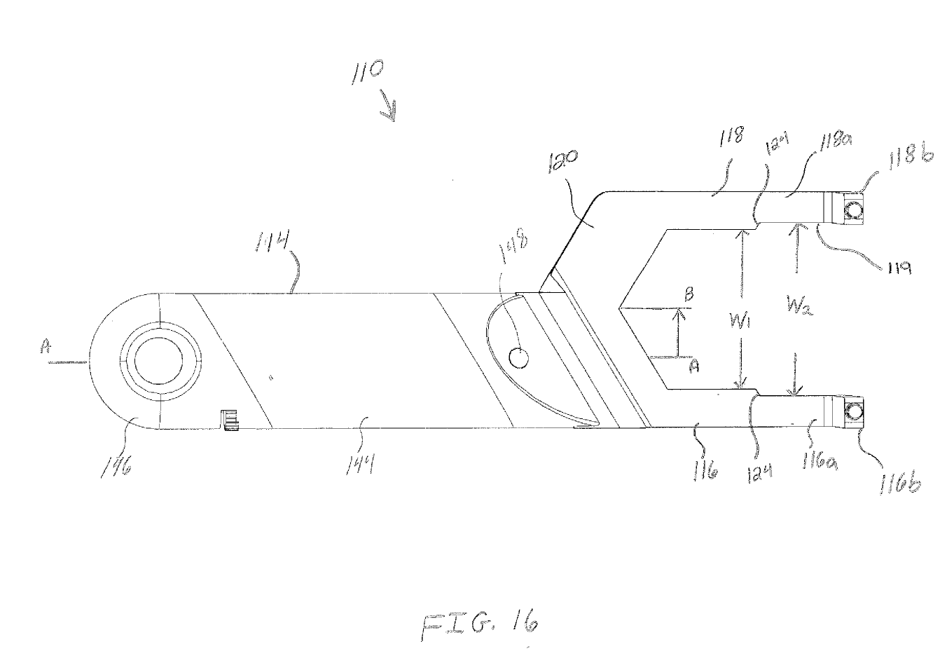

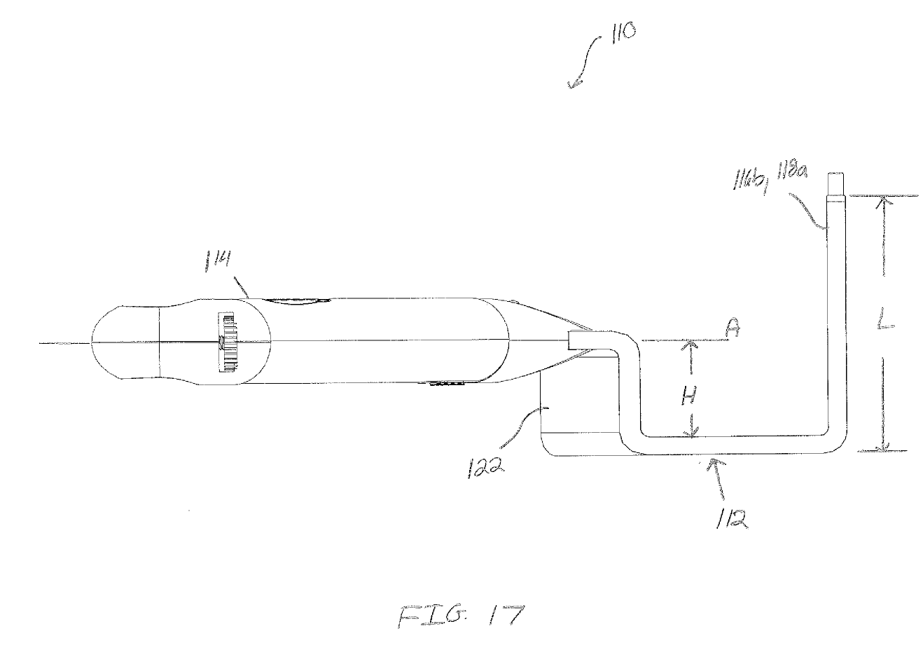

Referring to FIGS. 15-16, another embodiment of a drain nut driver 110 includes a drain nut engaging structure 112 affixed to a handle portion 114. The drain nut engaging structure 112 includes a pair of angular extensions 116 and 118. The extensions 116 and 118 each include extending sections 116a and 118a and engaging sections 116b and 118b. The engaging sections 116b and 118b are positioned at an angle “α” with respect to the extending sections 106a and 118a. For example, the angular extensions 116 and 118 can be substantially L-shaped, having an angle “α” of about 90°. Although the engaging sections 116b and 118b are shown being substantially perpendicular to the extending sections 116a and 118b (i.e., substantially L-shaped as previously described), any suitable angular relationship could be used.

The extensions 116 and 118 are provided in a spaced apart relationship for positioning about the drain pipe 16 and alignment with the pair of bores 28 and 30 in the drain nut 20. The extensions 116 and 118 are provided in a horizontal offset relation to a central longitudinal axis “A” of the handle portion 114, such that a central axis “B” of the extensions 116 and 118 is offset from the central axis longitudinal axis “A” of the handle portion 114. To provide the extension offset, a lever ann 120 is provided in extension 115. The lever ann 120 extends a sufficient length to accommodate the diameter of the drain pipe 16, defining an inner width “W₁.” The extension offset provides leverage to a user of the drain nut driver 110 to aid in the tightening or removal of the drain nut 20.

The tips 116c and 118c of the extensions 116 and 18 are shaped, sized, and dimensioned to one each slidingly engage one of the bores 28 and 30. The tips 116c and 118c of the extensions 116 and 118 are depicted having a circular cross sectional area. However, it is contemplated that the cross sectional area of tips 116c and 118c of the extensions 116 and 118 can have other shapes, including but not limited to, rectangular, triangular, elliptical, octagonal, hexagonal, diamond, star, etc., matching the cross sectional area of the bores 28 and 30. The present invention contemplates that tips 116c and 118c can have a shape that is different than the shape of bores 28 and 30. In the instance where the drain nut 20 includes multiple pairs of bores, the extensions 116 and 118 may be selectively positioned in any one of the pairs of bores. It is also noted that the tips 116c and 118c have a distinct structure compared to engaging sections 116b and 118b such that a shoulder is formed therebetween. This can provide tactile and/or audible feedback to the user that the tips 116c and 118c and securely engaged within bores 28 and 30.

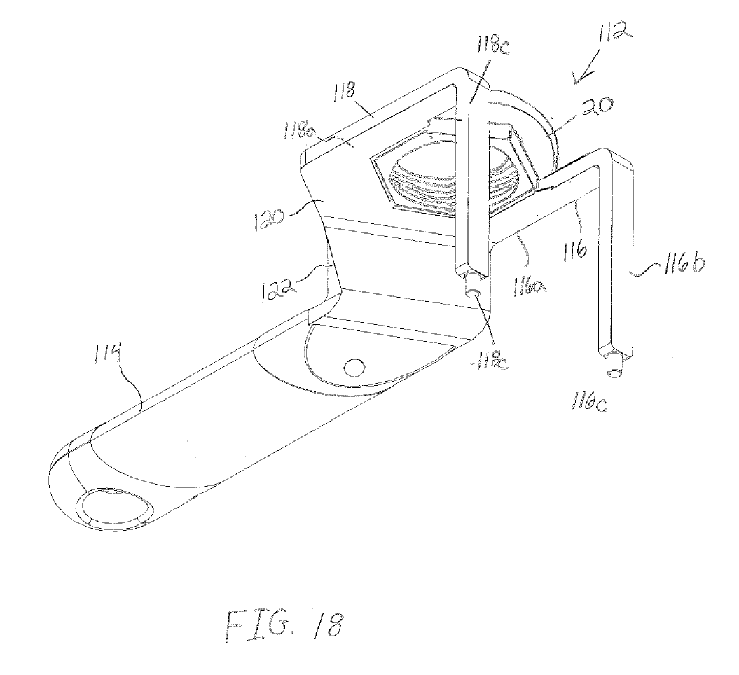

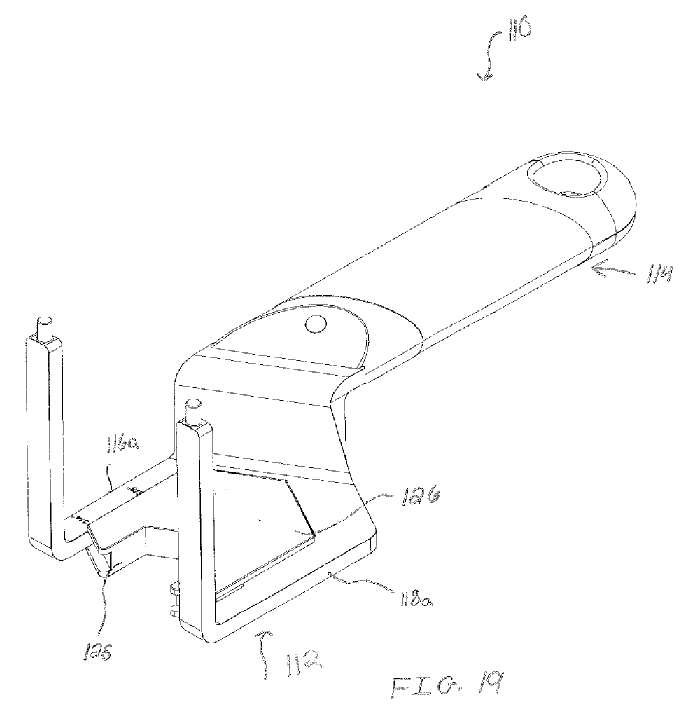

Referring also to FIG. 17, the drain nut engaging structure 112 is affixed to the handle portion 114 in a vertical offset relation to a central longitudinal axis “A” of the handle portion 114. A vertical extension member 122 is affixed to and positioned between the drain nut engaging structure 112 and the handle portion 114, such that the drain nut engaging structure 112 is offset a distance “H” from the central longitudinal axis “A” of the handle portion 114. The offset distance “H” is selected to provide a clearance between a hand of a user grasping the handle portion 114 and an underside surface of a sink on which the drain nut 20 is being installed. As described in more detail below, this is particularly useful when tool 110 is used as depicted in FIG. 18.

The vertical extension member 122 is depicted as being substantially orthogonal to the central longitudinal axis “A” of the handle portion 114 and the drain nut engaging structure. However, it is contemplated that the vertical extension member 122 can be affixed at any number of suitable angles (obtuse or acute angles) to the drain nut engaging structure 112 and the handle portion 114, such that an offset distance “H” is provided between the drain nut engaging structure 112 and the central longitudinal axis “A” of the handle portion 114.

In a “forks up” position, the tips 116c and 118c of the extensions 116 and 18 are positioned in an “up” position to one each slidingly engage one of the bores 28 and 30 of the drain nut 20. The drain nut engaging structure 112 is offset “down” the distance “H” from the central longitudinal axis “A” of the handle portion 114, where the engaging sections 116b and 118b each have a length “L,” such that when the tips 116c and 118c are coupled to one of the drain nut bores 28 and 30, the drain nut driver 110 can rotate freely about the drain pipe 16 to selectively tighten or loosen the drain nut 20 regardless of the length of the drain pipe 16. The length “L” is selected to provide a clearance between a hand of a user grasping the handle portion 114 and an underside surface of a sink on which the drain nut 20 is being installed. It is noted that drain nut driver 110 can be used in the forks up position for any diameter of the drain nut 20 as long as the tips 116c and 118c are coupled to drain nut bores 28 and 30.

Referring to FIG. 18, similar to drain nut engaging section 72 of drain nut driver 70, in a “forks down” position with the engaging sections 116b and 118b extending “down” away from the drain nut 20, the extending sections 116a and 118a of the drain nut engaging structure 112 can engage the drain nut 20. The extending sections 116a and 118a and the lever arm 120 combine in a polygon configuration matching that of the drain nut 20, where the inner width “W₁” of the extending sections 116a and 118a is of sufficient length to position the drain nut 20 there between, such that the extending sections 116a and 118a and lever arm 120 engage the drain nut 20. In this manner the drain nut 20 can be selectively tighten or loosen on the drain pipe 16. The inside edge of extending sections 116a and 118a, i.e. the surfaces that engage the drain nut 20 (one of which is shown as 119 in FIG. 16), can be substantially flat vertical surfaces to maximize the surface area contact between the extending sections 116a and 118a and the drain nut 20. Alternatively, the inside edges can be tapered.

In the “forks down” position, the drain nut engaging structure 112 is offset “up” the distance “H” from the central longitudinal axis “A” of the handle portion 114, where the engaging sections 116b and 118b extend “down” away from the drain nut 20. As previously noted, the offset distance “H” provides a clearance between a hand of a user grasping the handle portion 114 and an underside surface of a sink.

The extending section 116a and 118b can further include a second inner width “W₂,” where the extending section 116a and 118b can each include a step section 124 providing a transition between the first inner width “W₁” and the second inner width “W₂.” The first inner width “W₁” is less than the second inner width “W₂,” such that two different sized drain nuts 20 can be individually engaged by the extending section 116a and 118b in the “fork down” position. For example, the first inner width “W₁” can be sized to receive a 1⅝ inch drain nut, and the second inner width “W₂” can be sized to receive a 1¾ inch drain nut.

The step sections 124 can be provided in an angular relation, thereby foiling a pseudo-polygon configuration, substantially matching the configuration of the drain nut 20, Such that the extending sections 116a and 118a and the step sections 124 can engage the angular outer surfaces of the drain nut 20.

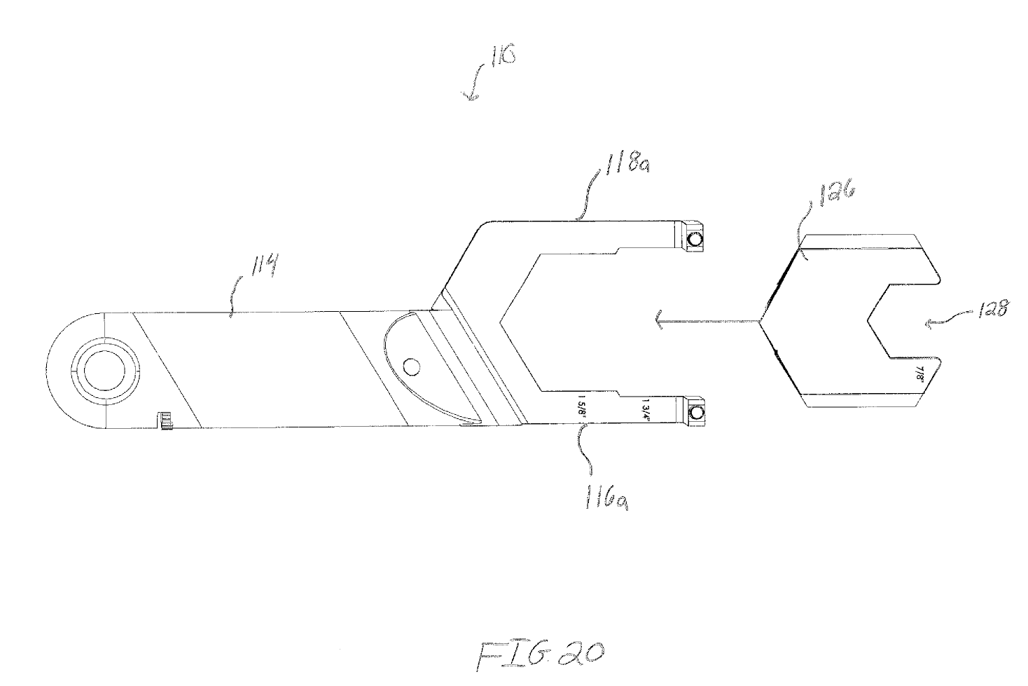

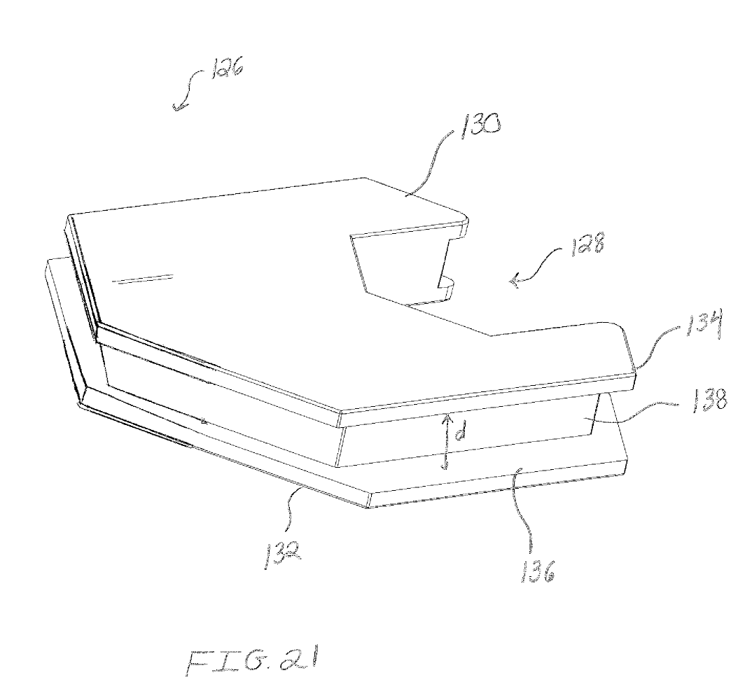

Referring to FIGS. 19-20, all insert piece 126 can be removably positioned onto the drain nut engaging structure 112. The insert piece 126 is slidingly positioned on the extending sections 116a and 118a, and includes at least one nut engaging section 128. The nut engaging section 128 is sized to engage a nut smaller than the drain nut 20, such the drain nut driver 110 can be used as a wrench to selectively loosen or tighten a nut. In this regard, water supply lines typically utilize nut sizes smaller than drain nuts. Thus, nut engaging section 128 can be configured and dimensioned to selectively loosen or tighten a water supply line nut.

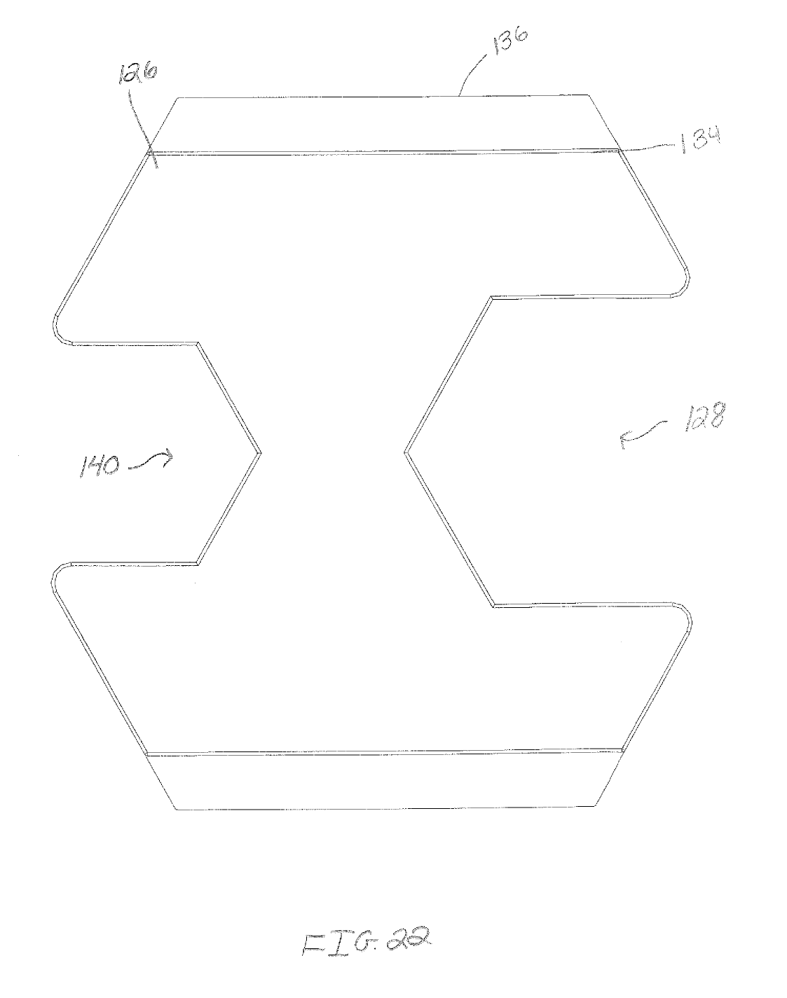

Referring also to FIG. 21, the insertion piece 126 includes a top surface 130 and a bottom surface 132. The top surface 130 includes a first outer edge 134 extending there from, and the bottom surface 132 includes a second outer edge 136 extending there from, such that a channel 138 is defined between the first and second outer edges 134 and 136. The insert piece 130 is configured such that the top surface 130 can be positioned between the engaging sections 116b and 118b, positioning the extending sections 116a and 118a in the channel 138, securing the insert piece 126 within drain nut engaging section 112.

In an embodiment, the top surface 130 is configured to have a width dimensioned between the first inner width “W₁” and the second inner width “W₂” of the extending member 116a and 118a. The bottom surface is configured to have a width dimensioned greater than the first inner width “W₁” and/or the second inner width “W₂.” In this manner, the insert piece is insertable, between the engaging sections 116b and 118b, where the extending sections 116a and 118a are positioned in the channel 138, securing the insert piece 126 within drain nut engaging section 112.

In an embodiment, the channel 138 has a height “d” which is greater than the thicknesses of the extending, sections 116a and 118a, such that the insertion piece 126 can be readily slid on and off the extending sections 116a and 118a. Alternatively, the height “d” of the channel 138 is substantially equal to or less than the thicknesses of the extending sections 116a and 118a, such that when the insertion piece 126 is positioned on the extending sections 116a and 118a, the first and second edges 134 and 138 frictionally secure the insertion piece 126 to the drain nut engaging structure 112.

In a further embodiment, at least one of the insertion piece 126 and the drain nut engaging structure 112 can be made of or include a magnetic or magnetizable material, such that insertion piece 126 is magnetically secured to the drain nut engaging structure 112. The present invention also contemplates that handle 114 is provided with a recess such that insertion piece 126 can be secured to handle 114 when not in use. The insertion piece 126 could also be tethered to either handle 114 or drain nut engaging structure 112 to help prevent loss when not in use.

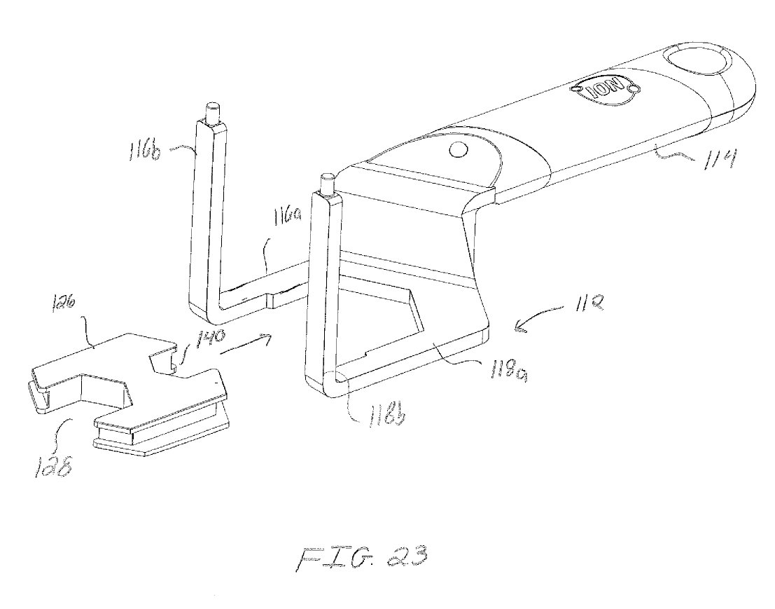

Referring to FIGS. 22 and 23, the insertion piece 126 can include a first nut engaging section 128 and a second nut engaging section 140, where the first and second nut engaging sections 128 and 140 are sized to engage different sized nuts. For example, the first nut engaging section 128 can be sized to engage a ⅞ inch nut and the second nut engaging section 140 can be sized to engage a ⅝ inch nut, which are common size nuts for water supply lines. The insertion piece 126 is selectively positionable into the drain nut engaging section 112, such that either the first or second nut engaging sections 128 or 140 can be used to selectively loosen or tighten a nut.

Referring again to FIGS. 15 and 16, the length of the handle portion 114 can be adjustable. The handle portion 114 can include an actuation member 142 to selectively adjust its length. In an embodiment, the adjustment mechanism of the handle portion 114 is similar to that of handle portion 74 of drain nut driver 70, as previously described and shown in FIGS. 10 and 11. However, any suitable mechanism that allows adjustment of the handle portion 114 length can be used.

Similar to drain nut driver 70, the outer handle portion 114 can further include a gripping element 144 positioned about the outer handle portion 146. The gripping element 144 can include a textured surface or coating about the outer handle portion 146, such that a user can more securely grip the drain nut driver 110, decreasing the likelihood of slipping.

Alternatively, the gripping element 144 can include an outer sleeve positioned about the outer handle portion 146. The outer sleeve can be made of a flexible material, which can be securely positioned about the outer handle portion 146, such that a user can more securely grip the drain nut driver 110, decreasing the likelihood of slipping. The outer sleeve can further include a textured surface, which can further decrease the likelihood of slipping.

Similar to drain nut driver 70, drain nut driver 110 can include a light element 148 positioned adjacent to extensions 116 and 118. The light element 148 can be selectively turned on and off, and used to illuminate the drain nut 20, thereby facilitating the drain nut driver 110 engagement of the drain nut 20. In an embodiment, the light element 148 of drain nut driver 110 is similar in configuration and operation to that of light clement 96 of drain nut driver 70, previously described herein. In another embodiment, light element 148 is configured and dimensioned such that the illumination is provided on the drain nut 20 in either the “forks up” or “forks down” position.

In use, the drain nut 20 is threaded onto the drain pipe 16 with the drain nut driver 110. The drain nut 20 is threaded onto the drain pipe 16, wherein the internal threads 32 of the drain nut 20 engage the threaded drain pipe 16. The drain nut 20 is positioned on the drain pipe 16, such that the flange portion 24 of the drain nut 20 would be proximal to the underside surface of the plumbing fixture.

In the “forks up” position, the drain nut driver 110 engages the drain nut 20 by positioning the angular extensions 116 and 118 about the drain pipe. The tips 116c and 118c of the engaging sections 116b and 118b of each of the angular extensions 116 and 118 are slidably inserted into the drain nut bores 28 and 30. The light element 148 can be turned on to aid in the placement of the engaging sections 116b and 118b into the drain nut bores 28 and 30.

The handle portion 114 is rotated around the drain pipe 16, threading the drain nut 20 onto the drain pipe 16. To secure the drain assembly in position, the drain nut 20 is threaded onto the drain pipe 16, wherein the flange portion 24 of the drain nut 20 abuts an underside surface of the plumbing fixture. Sufficient torque is applied to the drain nut 20, securing the drain assembly 10 into position.

Similarly, to remove the drain assembly 10, the drain nut driver 110 engages the drain nut 20 by positioning the angular extensions 116 and 118 about the drain pipe 16. The tips 116c and 118c of the engaging sections 116b and 118b of each of the angular extensions 116 and 118 are slidably inserted into the drain nut bores 28 and 30. The handle portion 114 is rotated around the drain pipe 16, rotating the drain nut 20 off the drain pipe 16. The drain nut 20 is removed from the drain pipe 16.

In the “forks down” position, the drain nut driver 110 engages the drain nut 20 by positioning the angular extensions 116 and 118 about the drain pipe. The extending sections 116a and 118a are positioned about the drain nut 20, where the extending sections 116a and 118a and lever arm 120 engage the outer surface of the drain nut 20. Depending on the size of the drain nut 20, extending sections 116a and 118a engage the drain nut 20 either between the first inner width “W₁” or the second inner width “W₂”. Furthermore, if insertion piece 126 is in place, either first or second nut engaging sections 128 or 140 can be used to selectively loosen or tighten a nut.

The handle portion 114 is rotated around the drain pipe 16, threading the drain nut 20 onto the drain pipe 16. To secure the drain assembly in position, the drain nut 20 is threaded onto the drain pipe 16, wherein the flange portion 24 of the drain nut 20 abuts an underside surface of the plumbing fixture. Sufficient torque is applied to the drain nut 20, securing the drain assembly 10 into position.

Similarly, to remove the drain assembly 10, the drain nut driver 110 engages the drain nut 20 by positioning the angular extensions 116 and 118 about the drain pipe 16. The extending sections 116a and 118a are positioned about the drain nut 20, where the extending sections 116a and 118a and lever arm 120 engage the outer surface of the drain nut 20. Again and depending on the size of the drain nut 20, extending sections 116a and 118a engage the drain nut 20 either between the first inner width “W₁” or the second inner width “W₂”. Furthermore, if insertion piece 126 is in place, either first or second nut engaging sections 128 or 140 call be used to selectively loosen or tighten a nut. The handle portion 114 is rotated around the drain pipe 16, rotating the drain nut 20 off the drain pipe 16. The drain nut 20 is removed from the drain pipe 16.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention.

What is claimed is:

1. A driver tool for threading a drain nut about a threaded drain pipe, comprising:
a handle portion; and
a pair of angular extensions affixed to the handle portion in a spaced apart relationship to be fitted about the drain pipe, each of the angular extensions including an extending section proximal to the handle portion, and an engaging section extending from the extending section, wherein the engaging section extends at an angle with respect to the extending section.

2. The driver tool of claim 1, wherein the handle portion defines a handle central longitudinal axis and the pair of angular extensions define a central axis, and the pair of angular extensions are affixed to the handle portion such that the central axis is offset from the handle central longitudinal axis.

3. The driver tool of claim 2, wherein the central axis is vertically offset from the handle central longitudinal axis.

4. The driver tool of claim 2, wherein the central axis is horizontally offset from the handle central longitudinal axis.

5. The driver tool of claim 2, wherein the central axis is vertically and horizontally offset from the handle central longitudinal axis.

6. The driver tool of claim 1, wherein the extending sections arc configured to engage the drain nut.

7. The driver tool of claim 6, wherein the space-apart relationship of the pair of angular extensions define a first width between the extending sections.

8. The driver tool of claim 7, wherein the extending sections each include a step section, defining a second width between the extending sections, wherein the second width is greater than the first width.

9. The driver tool of claim 1 wherein the handle portion has an adjustable length.

10. The driver tool of claim 1, further comprising:
a light positioned in the handle portion, proximal to the pair of angular extensions;
a switch positioned in the handle portion; and
a power supply operably connected to the light and the switch.

11. The driver tool of claim 1, further comprising an insertion piece removably positionable between the pair of angular extensions.

12. The driver tool of claim 11, wherein the insertion piece includes a first section configured and dimensioned to receive a first nut size.

13. The driver tool of claim 12, wherein the insertion piece includes a second section configured and dimensioned to receive a second nut size different than the first nut size.

14. A driver tool for threading a drain nut about a threaded drain pipe, comprising:
a handle portion defining a handle central longitudinal axis; and
a drain nut engaging portion include a pair of extending sections and a pair of engaging sections, one each extending from the extending sections, wherein the encaging sections extends at an angle with respect to the extending section, the pair of extending section being provided in a spaced-apart relationship defining central axis,
wherein the drain nut engaging portion is affixed to the handle portion such that the handle longitudinal axis is offset vertically and horizontally from the central axis.

15. The driver tool of claim 14, further comprising an insertion piece removably positionable between the pair of extending section.

16. The driver tool of claim 15, wherein the insertion piece includes a first section configured and dimensioned to receive a first nut size therein.

17. The driver tool of claim 16, wherein the insertion piece include a second section configured and dimensioned to receive a second nut size therein, wherein the first nut size is different from the second nut size.

18. The driver tool of claim 14, wherein the pair of extending sections are configured and dimensioned to receive a first drain nut size therein.

19. The driver tool of claim 18, wherein the pair of extending sections includes a transition section, such that first and second widths are defined between the pair extending sections.

20. The driver tool of claim 19, where the pair of extending sections are configured and dimensioned to receive the first drain nut size in the first width and a second drain nut size in the second width.

21. The driver tool of claim 14, wherein the engaging sections each includes a tip portion configured to engage a bore in the drain nut.

22. The driver tool of claim 14, wherein the handle portion has an adjustable length.

23. The driver tool of claim 14, further comprising:
a light positioned in the handle portion, proximal to the pair of extending sections;
a switch positioned in the handle portion; and
a power supply operably connected to the light and the switch.

24. A drain connection kit for connecting a drain pipe having an exterior threading to a plumbing fixture, comprising:
a drain nut having first and second bores, and an annular wall with a threading, the annular wall threading configured and dimensioned to threadably engage the drain pipe exterior threading; and
a driver tool having a first angular extension configured and dimensioned to removably engage the first bore and a second angular extension configured and dimensioned to removably engage the second bore such that rotation of the driver tool about the drain pipe rotates the drain nut, wherein the first and second angular extensions are provided in a spaced apart relationship to be fitted about the drain pipe.
